(19) United States
(12) Patent Application Publication
(10) Pub. No.: US 2013/0239926 A1
(43) Pub. Date: Sep. 19, 2013

(54) DRIVE TRAIN AND METHOD FOR OPERATING SAME

(71) Applicant: Johannes Glueckler, Friedrichshafen (DE)

(72) Inventor: Johannes Glueckler, Friedrichshafen (DE)

(73) Assignee: ZF FRIEDRICHSHAFEN AG, Friedrichshafen (DE)

(21) Appl. No.: 13/990,298

(22) PCT Filed: Nov. 7, 2011
(86) PCT No.: PCT/EP2011/069541

§ 371 Date: May 29, 2013

(30) Foreign Application Priority Data
Dec. 3, 2010 (DE) 10 2010 062 381.4

(51) Int. Cl. F02B 61/06

(52) U.S. Cl. CPC F02B 61/06
USPC 123/319

(57) ABSTRACT

A drive-train of a motor vehicle, with a drive aggregate comprising at least an internal combustion engine (1), a transmission (3) connected between the internal combustion engine (1) and the drive output (2), and a starting clutch (4) connected between the internal combustion engine (1) and the transmission (3). The drive aggregate also has a shiftable by-pass transmission (5) arranged parallel to the starting clutch (4) which has at least one gear step (6), and an auxiliary clutch (7). In order to reduce the speed of the internal combustion engine (1), during overrun operation of the drive-train, the auxiliary clutch (7) is engaged and the starting clutch (4) is at least partially disengaged.

This application is a national stage completion of PCT/EP2011/069541 filed Nov. 7, 2011 which claims priority from German Application serial No. 10 2010 062 381.4 filed Dec. 3, 2010.

### FIELD OF THE INVENTION

The invention concerns a drive-train and a method for operating a drive-train.

### BACKGROUND OF THE INVENTION

Besides a drive aggregate, a drive-train of a motor vehicle comprises a transmission connected between the drive aggregate and a drive output. The present invention concerns a drive-train and a method for operating a drive-train whose drive aggregate comprises at least an internal combustion engine and sometimes also an electric machine. A drive aggregate which in addition to an internal combustion engine also comprises an electric machine is referred to as a hybrid drive.

From practice it is already known to operate a drive-train with an internal combustion engine, when the drive-train is operating in overrun mode, with a so-termed overrun fuel cut off such that in the overrun fuel cut off mode, when the drive-train is closed no fuel is injected into the internal combustion engine.

During such overrun fuel cut off operation the internal combustion engine runs at an entrained speed that depends on a gear engaged in the transmission, and by virtue in particular of internal friction in the internal combustion engine, drag losses occur. The higher the speed of the internal combustion engine running in the entrained overrun mode, the greater are its drag losses.

It is therefore advantageous, when a drive-train is in overrun operation, for the speed of the internal combustion engine to be kept low in order to reduce drag losses of the internal combustion engine.

From DE 10 2007 004 412 A1 it is already known that in addition to the gears provided for driving operation, a transmission can contain other gears for overrun operation with overrun fuel cut off, such that these additional gears have lower gear ratios than the gears for driving operation in order to reduce the drag torque of the internal combustion engine that acts upon the drive output. It is true that the provision of additional gears in the transmission of the drive-train for overrun operation enables drag losses to be reduced during overrun operation of the drive-train, but such a solution entails design modifications of the transmission. There is a need for a drive-train and a method for operating it, with the help of which drag losses can be reduced even without design modifications of the transmission.

### SUMMARY OF THE INVENTION

Starting from there the purpose of the present invention is to provide a new type of drive-train and a method for operating a drive-train, with which drag losses of the internal combustion engine can be reduced when the drive-train is in overrun operation.

According to a first aspect of the invention, the drive-train comprises a by-pass transmission that can be engaged parallel to the starting clutch, having at least one gear step and an auxiliary clutch, such that in order to reduce the speed of the internal combustion engine during overrun operation of the drive-train, the auxiliary clutch is closed and the starting clutch is at least partially opened.

According to a second aspect of the invention, the drive-train comprises a shiftable axle transmission connected between the transmission and the drive output, such that to reduce the speed of the internal combustion engine during overrun operation of the drive-train a shift is or can be carried out in the axle transmission.

With both aspects of the invention, the speed of the internal combustion engine can be reduced during overrun operation of the drive-train and thereby drag losses of the internal combustion engine can be reduced, and this without design modifications of the transmission.

### BRIEF DESCRIPTION OF THE DRAWINGS

Preferred further developments of the invention emerge from the description given below. Example embodiments of the invention, to which it is not limited, are explained in more detail with reference to the drawing, which shows:

FIG. 1: A schematic representation of a drive-train according to another aspect of the invention;

FIG. 2: A schematic representation of a drive-train according to a first aspect of the invention; and

FIG. 3: A diagram to illustrate the method according to the invention for operating a drive-train.

### DETAILED DESCRIPTION OF THE DRAWINGS

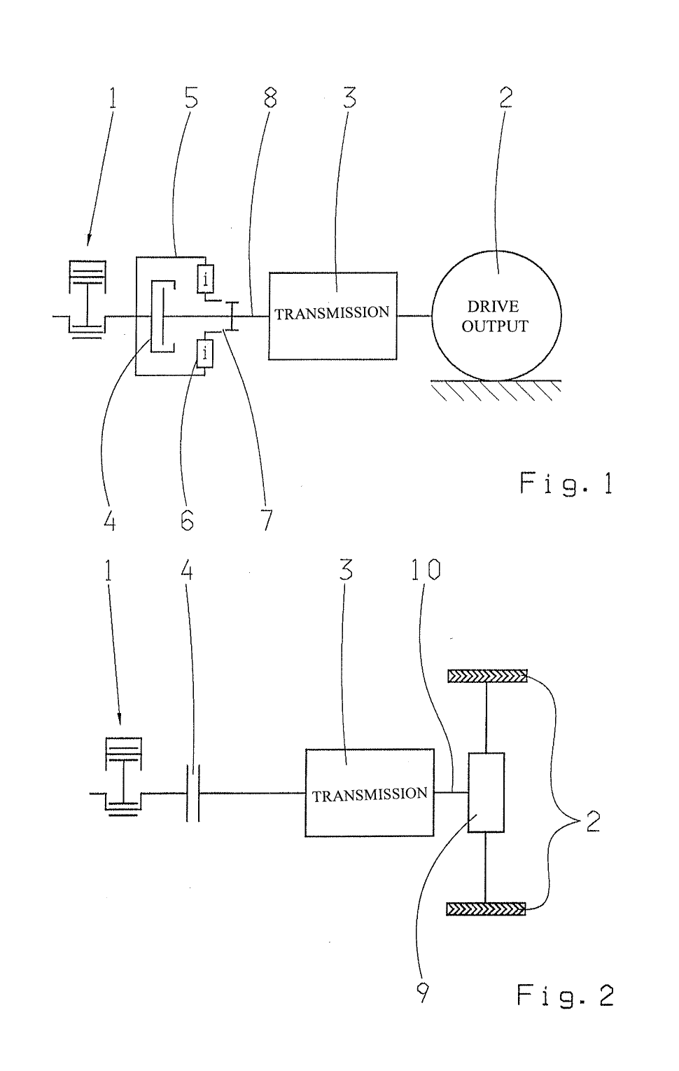

The present invention concerns a drive-train of a motor vehicle and a method for operating a drive-train of a motor vehicle, by virtue of which during overrun operation of the drive-train drag losses of an internal combustion engine of the drive-train can be reduced. Below, the invention is described in detail with reference to FIGS. 1 to 3.

FIG. 1 shows a drive-train layout of a drive-train according to the invention, considering a first aspect of the invention such that the drive-train represented in FIG. 1 comprises an internal combustion engine 1, with a transmission 3 connected between the internal combustion engine 1 and a drive output 2. The transmission 3 is preferably an automatic or automated change-speed transmission.

Between the internal combustion engine 1 and the transmission 3 is connected a starting clutch 4, the starting clutch 4 being in the form of a friction clutch. When the clutch 4 is fully open it cannot transmit any torque and the drive-train is then open, with the internal combustion engine 1 being decoupled from the drive output 2. On the other hand, when the clutch 4 is fully closed the internal combustion engine 1 is coupled to the drive output 2 and the drive-train is closed. Moreover, the starting clutch 4, made as a friction clutch, can be operated with slip and friction work is then performed at the clutch 4.

The drive-train according to the invention shown in FIG. 1 also comprises, in addition to the internal combustion engine 1, the transmission 3 and the starting clutch 4, a shiftable by-pass transmission 5 parallel to the staring clutch 4 with at least one gear step 6 and an auxiliary clutch 7, such that when the auxiliary clutch 7 is closed the staring clutch 4 is by-passed via the by-pass transmission 5, while in contrast, when the auxiliary clutch 7 is open the starting clutch 4 cannot be by-passed.

In order, now, during overrun operation of the drive-train to reduce the speed of the internal combustion engine 1, during overrun operation of the drive-train the auxiliary clutch 7 is closed whereas the starting clutch 4 is opened, at least partially and preferably completely.

In contrast to the starting clutch 4, the auxiliary clutch 7 is preferably an interlocking clutch which is either open or closed and cannot therefore be operated with slip.

During overrun operation, in which the internal combustion engine 1 is operated with overrun fuel cut off, the interlocking auxiliary clutch 7 is closed and the frictional starting clutch 4 is preferably opened far enough for it not to transmit any torque.

The by-pass transmission 5 is preferably a planetary transmission or a spur gear transmission with at least one gear step 6, wherein the, or each gear step 6 of the by-pass transmission 5 is chosen such that during overrun operation the speed of the internal combustion engine 1 is reduced and is accordingly slower or less than the rotational speed of an input shaft 8 of the transmission 3.

Although while the drive-train of FIG. 1 is in overrun operation the frictional starting clutch 4 is preferably opened far enough for it to no longer transmit any torque, if necessary the starting clutch 4 can also be operated with slip during overrun operation with the auxiliary clutch 7 closed. Likewise, with the auxiliary clutch 7 open, the starting clutch 4 can be operated with slip in order to reduce the speed of the internal combustion engine 1 during overrun operation.

As already explained, in the example embodiment shown, the auxiliary clutch 7 connected between the frictional clutch 4 and the transmission 3 is an interlocking clutch, preferably an interlocking claw clutch.

In order to close the auxiliary clutch 7, with the help of the starting clutch 4 operating with slip, a speed synchronization for the interlocking auxiliary clutch 7 can be carried out.

To open the interlocking auxiliary clutch 7, by operating the starting clutch 4 with slip the torque at the auxiliary clutch 7 can be relieved.

Thus, the starting clutch 4 is operated with slip both when opening and when closing the auxiliary clutch 7.

A further, alternative form of the invention is illustrated in FIG. 2 which shows a drive-train with an internal combustion engine 1 and a transmission 3 connected between the internal combustion engine 1 and a drive output 2, as well as a staring clutch 4 connected between the internal combustion engine 1 and the transmission 3.

In addition, the drive-train in FIG. 2 has an axle transmission 9 connected between the transmission 3 and the drive output 2, the axle transmission 9 being a shiftable axle transmission 9 in which, to reduce the speed of the internal combustion engine 1 during overrun operation of the drive-train, a shift can be carried out to a gear in which a rotational speed of a transmission input shaft 10 of the transmission 3 can be reduced, so that ultimately the speed of the internal combustion engine 1 as well can be reduced during overrun operation with an overrun fuel cut off.

With both aspects of the invention it is possible, during overrun operation of the drive-train, i.e. when the internal combustion engine 1 is operating with overrun fuel cut off when no fuel is being delivered, to reduce the speed of the internal combustion engine 1 so as to reduce drag losses of the internal combustion engine 1.

Thus, FIG. 3 shows a diagram in which a drag torque M_{S} of the internal combustion engine 1 is plotted as a function of the speed n_{VM} thereof. From FIG. 3 it can be seen that as the speed n_{VM} of the internal combustion engine 1 increases so too does the drag torque M_{S}, whereas with the invention, during overrun operation, in FIG. 1 by closing the auxiliary clutch 7 and opening the starting clutch 4 and in FIG. 2 by carrying out a shift in the axle transmission 9, the operating point of the internal combustion engine 1 can be displaced from operating point A to operating point B, with a consequent speed reduction from the speed n_{A} to the speed n_{B} and therefore with a reduction of the drag torque from torque M_{A} to torque M_{B}. Thus, as shown in FIG. 3 the drag torque M_{S} can be reduced by the amount ΔM_{S}.

With the invention it is possible, for example when driving downhill in overrun operation, to extend the distance covered by the drive-train over which no fuel has to be delivered to the internal combustion engine 1, since due to the reduction of the drag torque or drag losses of the internal combustion engine 1, a demand for power from the engine can be deferred. Furthermore, the invention makes it possible to make more prolonged use of a coasting function for the drive-train. If the drive aggregate of the drive-train according to the invention is a hybrid drive comprising at least one electric machine in addition to the internal combustion engine 1, then when driving downhill in overrun operation more braking energy can be recovered and thus more electrical energy can be gained, since the drag losses in the internal combustion engine 1 are lower so less energy has to be used to overcome the drag torque of the internal combustion engine 1. Therefore an electrical energy accumulator can be more fully charged and that energy can be made available for electric motor operation. Ultimately this results in a reduction of the fuel required.

### Indexes

1 Internal combustion engine
2 Drive output
3 Transmission
4 Starting clutch
5 By-pass transmission
6 Gear step
7 Auxiliary clutch
8 Input shaft
9 Axle transmission
10 Output shaft

1-10. (canceled)

11. A drive-train of a motor vehicle with a drive aggregate comprising:
at least an internal combustion engine (1),
a transmission (3) being connected between the internal combustion engine (1) and a drive output (2),
a starting clutch (4) being connected between the internal combustion engine (1) and the transmission (3),
a shiftable by-pass transmission (5), arranged parallel to the starting clutch (4), having at least one gear step (6), and
an auxiliary clutch (7),
and, during overrun operation of the drive-train, the auxiliary clutch (7) being engaged and the starting clutch (4) being at least partially disengaged to reduce a speed of the internal combustion engine (1).

12. The drive-train according to claim 11, wherein to reduce the speed of the internal combustion engine (1), the auxiliary clutch (7), which is an interlocking clutch, is engaged and the starting clutch (4), which is a friction clutch, is at least partially disengaged to operate with slip.

13. The drive-train according to claim 11, to reduce the speed of the internal combustion engine (1), the starting clutch (4) is disengaged to prevent torque transmission thereby.

14. The drive-train according to claim 11, wherein the by-pass transmission (5) is either a planetary transmission or a spur gear transmission.

15. A method of operating a drive-train of a motor vehicle having a drive aggregate comprising at least an internal combustion engine (1), a transmission (3) being connected between the internal combustion engine (1) and a drive output (2), a starting clutch (4) being connected between the internal combustion engine (1) and the transmission (3), a shiftable by-pass transmission (5), arranged parallel to the starting clutch (4), having at least one gear step (6), and an auxiliary clutch (7), the method comprising the steps of:
engaging the auxiliary clutch; and
at least partially disengaging the starting clutch while the drive-train operates in overrun operation to reduce the speed of the internal combustion engine.

16. The method according to claim 15, further comprising the step of carrying out a speed synchronization of the auxiliary clutch by operating the starting clutch with slip to engage the auxiliary clutch.

17. The method according to claim 15, further comprising the step of relieving torque of the auxiliary clutch by operating the starting clutch with slip to disengaged the auxiliary clutch.

18. The method according to claim 15, further comprising the step of choosing a gear step in the by-pass transmission, by virtue of which the internal combustion engine runs slower than does a transmission input shaft of the transmission.

19. A drive-train of a motor vehicle having a drive aggregate comprising:
at least an internal combustion engine (1),
a transmission (3) being connected between the internal combustion engine (1) and a drive output (2),
a starting clutch (4) being connected between the internal combustion engine (1) and the transmission (3),
an axle transmission (9) being connected between the transmission (3) and the drive output (2) for to reducing the speed of the internal combustion engine (1) during overrun operation of the drive-train, and a shift can be carried out in the axle transmission (9).

20. A method for operating a drive-train according to claim 19, further comprising the steps of:
carrying out a shift in the axle transmission (5) to a gear which reduces a transmission output speed of the transmission (3) so as to reduce a speed of the internal combustion engine (1) during an overrun operation of the drive-train.
